(19) United States
(12) Patent Application Publication
(10) Pub. No.: US 2007/0153016 A1
(43) Pub. Date: Jul. 5, 2007

(54) Method for publishing dialogue

(76) Inventor: G. Dean Steinman, Silver Spring, MD (US)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 11/639,138

(22) Filed: Dec. 15, 2006

Related U.S. Application Data
(60) Provisional application No. 60/750,813, filed on Dec. 16, 2005.

(51) Int. Cl. G09G 5/00

(52) U.S. Cl. 345/581

(57) ABSTRACT

A method of preparing dialogue in printed media includes defining/identifying character ‘voices’ by the means of type family, size, weight, and color. Any combination of type family or colors may be used in any order. The ‘code’ defines a ‘style’ of writing that introduces or defines each character in the story line, as they appear, with a different type family/style/color so that the reader will perceive the ‘speaker’, via the supplied code (or from context), by recognition of the differing type colors and styles presenting the dialog, much like seeing individual actors in a movie and recognizing their appearance of hearing their voice thus eliminating much of the grammatical narrative, i.e. “He said,”, “, she exclaimed.”, “, he loudly retorted.”.

### CROSS REFERENCE TO RELATED APPLICATIONS

This application is an application filed under 35 U.S.C. § 111(a) claiming benefit pursuant to 35 U.S.C. § 119(e)(1) of the filing date of the Provisional Application 60/750,813 filed on Dec. 16, 2005 pursuant to 35 U.S.C. § 111(b).

### BACKGROUND OF THE INVENTION

### FIELD OF THE INVENTION

The present invention relates generally to the field of printed media and more particularly to a method and device in which character ‘voices’ in printed media are defined and/or identified by the means of type family, size, weight, and color.

### SUMMARY OF THE INVENTION

In accordance with an exemplary embodiment of the invention, a method of preparing printed media is provided which comprises providing at least one character voice in the printed media, wherein each of the at least one voice is distinguished in the printed media from other voices in the printed media by utilizing at least one of a unique type face, type size, type weight, and type color for each respective character voice.

According to a further exemplary embodiment, a printed media device is provided which comprises printed media in which respective voices of at least one character are expressed in print, wherein each of the at least one voice is distinguished in the printed media from other voices in the printed media by utilizing at least one of a unique type face, type size, type weight, and type color for each respective character voice.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The object and features of the present invention will become more readily apparent from the following detailed description of the preferred embodiments taken in conjunction with the accompanying drawings in which:

FIG. 1 is an exemplary dialogue prepared in accordance with the present invention.

### DETAILED DESCRIPTION OF EXEMPLARY EMBODIMENTS

A method and device for defining/identifying character ‘voices’ in printed media by means of type face, size, weight, and color. The examples set forth here are not fixed. Any combination of type families or colors may be used in any order. The intent of this ‘code’ is to define a ‘style’ of writing that introduces or defines each character in the story line, as they appear, with a different type family/style/color so that the reader will perceive the ‘speaker’, via the supplied code (or from context), by recognition of the differing type colors and styles presenting the dialog, much like seeing individual actors in a movie and recognizing their appearance or hearing their voice thus eliminating much of the grammatical narrative, i.e. “He said,”, “, she exclaimed.”, “, he loudly retorted.”.

The following is an exemplary embodiment in accordance with the invention: In accordance with this embodiment, the host or narrator of the story is portrayed with a sans-serif, light weight (opposite of bold compared to normal weight) small family type, example 10 point Arial. Emphasis would be indicated by bolding the font.

The first speaking character, if not the main most speaking character, is represented by brown type, 12 point Souvenir when speaking in a normal voice, 10 point brown Souvenir when speaking softly, 11 point bold when speaking loudly, and 12 point italic when thinking. The main character is portrayed in black type using the same code of point sizes of 12—normal, 10—softly, 11 bold—loudly, and 12 italic—thinking. A skilled artisan would know that the specific type families, etc., used in this exemplary embodiment are not required to be within the scope of this invention. Various mixtures of different type families, colors, type strengths, etc. can be used. Specifically, it is the concept of using different colors of type (any easily discernable from other previously used colors) and different styles of type families (any easily discernable from other previously used type families), and differing type family weights that is intended to be within the scope of this disclosure.

Each newly presented character would be represented by a different color of type, e.g., green, blue, purple, and orange. As many colors may be used as are necessary, as long as they are discernibly different from other colors in the printed matter, to represent each speaking character. All characters, colors of type, would follow the same code as above, 12 point Souvenir when speaking in a normal voice, 10 point Souvenir when speaking softly, 11 point bold when speaking loudly, and 12 point italic when thinking.

When the number of speaking characters exceeds the number of easily discernable colors a new type family will be used, for example, Times Roman. Attention should be paid to selecting a type family that is noticeably different in appearance than any previously used type family. Colors previously used may now be reused with the new type family. As colors and type families change for each newly introduced character, the same code for speaking normally, softly, loudly, and thinking should be used as indicated above.

According to further exemplary embodiments of the invention, type point sizes might be varied by the publisher but the same code relation should be maintained. If a large print publication were to be produced, it might represent the dialogue as 18 point Souvenir when speaking in a normal voice, 14 point Souvenir when speaking softly, 16 point bold when speaking loudly, and 18 point italic when thinking.

A key to the code to the type family and color of type used should be presented in each printed work.

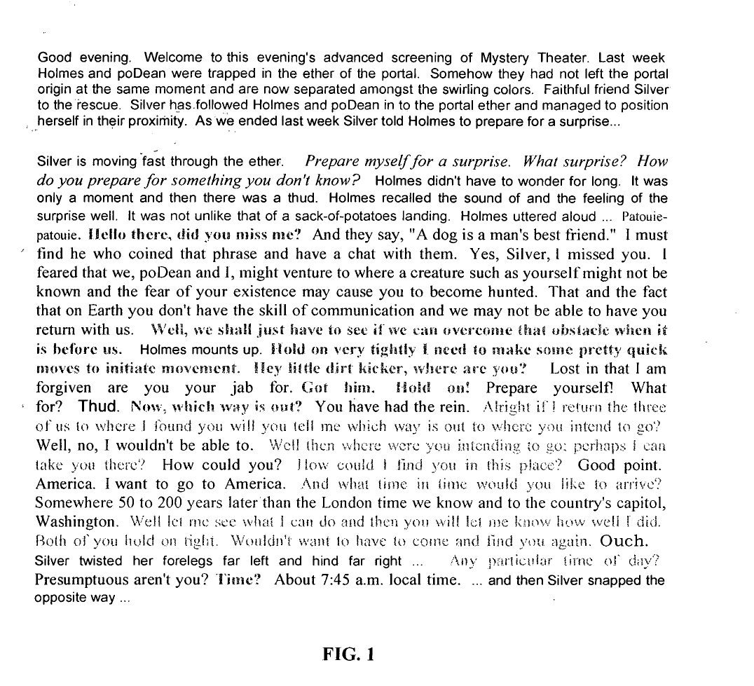

The following is an exemplary dialogue demonstrating an embodiment of the invention described above. In particular, within the dialogue several parentheses are provided in which are the data that identifies the different type family, style and color associated with the text immediately preceding the parenthetical. For example, if text within the dialogue is 12 point times roman, italics and purple, to identify the thoughts of a particular character in the dialogue, the thoughts would be written, in accordance with the example, below, and immediately followed by the parenthetical “(12 TR, ital, purple)”. However, a skilled artisan would understand that an actual dialogue in accordance with this example would actually include purple, 12-point type in italicized times roman font. The exemplary embodiment disclosed below is similar to the dialogue provided in FIG. 1. However, the dialogue below provides the identifying indicia by way of parenthetical information while the dialogue in FIG. 1 uses the actual type family, style and color.

### EXAMPLE

Subject: Holmes existence not unlike that of a little dirt kicker.

Good evening. Welcome to this evening's advanced screening of Mystery Theater. Last week Holmes and poDean were trapped in the ether of the portal. Somehow they had not left the portal origin at the same moment and are now separated amongst the swirling colors. Faithful friend Silver to the rescue. Silver has followed Holmes and poDean in to the portal ether and managed to position herself in their proximity. As we ended last week Silver told Holmes to prepare for a surprise . . . (10 Arial, regular, black).

Silver is moving fast through the ether. (10 Arial, regular, black) Prepare myself for a surprise. What surprise? How do you prepare for something you don't know? (12 TR, italics, purple) Holmes didn't have to wonder for long. It was only a moment and then there was a thud. Holmes recalled the sound of and the feeling of surprise well. It was not unlike that of a sack-of-potatoes landing. Holmes uttered aloud . . . (10 Arial, regular, black) Patouie-patouie. (10 TR, regular, purple) Hello there, did you miss me? (12 TR, bold, green) And they say, “A dog is a man's best friend.” I must find he who coined that phrase and have a chat with them. Yes, Silver I missed you. I feared that we, poDean and I, might venture to where a creature such as yourself might not be known and the fear of your existence may cause you to become hunted. That the fact that on Earth you don't have the skill of communication and we may not be able to have you return with us. (12 TR, regular, purple)

Well, we shall just have to see if we can overcome that obstacle when it is before us. (12 TR, bold, green) Holmes mounts up. (10 Arial, regular, black) Hold on very tightly I need to make some pretty quick moves to initiate movement. Hey little dirt kicker, where are you? (12 TR, bold, green) Lost in that I am forgiven are you your jab for. (12 TR, regular, brown) Got him. Hold on! (12 TR, bold, green) Prepare yourself! (12 TR, regular, purple) What for? (12 TR, regular, brown) Thud. (12 Arial, regular, black) Now, which way is out? (12 TR, bold, green) You have had the rein. (12 TR, regular, purple) Alright if I return the three of us to where I found you will you tell me which way is out to where you intend to go? (12 TR, regular, green) Well, no, I wouldn't be able to. (12 TR, regular, purple) Well then where were you intending to go; perhaps I can take you there? (12 TR, regular, green) How could you? (12 TR, regular, purple) How could I find you in this place? (12 TR, regular, green) Good point. America. I want to go to America. (12 TR, regular, purple) And what time in time would you like to arrive? (12 TR, regular, green) Somewhere 50 to 200 years later than the London time we know and the country's capitol, Washington. (12 TR, regular, purple) Well let me see what I can do and then you will let me know how well I did. Both of you hold on tight. Wouldn't want to have to come and find you again.(12 TR, regular, green). Ouch. (12 Arial, regular, purple) Silver twisted her forelegs far left and hind far right . . . (10 Arial, regular, black) Any particular time of day? (12 TR, regular, green) Presumptuous aren't you? (12 TR, regular, purple) Time? (12 TR, bold, green) About 7:45 a.m. local time. (12 TR, regular, purple) . . . and then Silver snapped the opposite way . . . (10 Arial, regular, black)

What is claimed is:

1. A method for publishing dialogue comprising identifying character ‘voices’ in printed media by the means of type family, size, weight, and color. The examples set forth here are not fixed. Any combination of families or colors may be used in any order. The intent of this ‘code’ is to define a ‘style’ of writing that introduces or defines each character in the story line, as they appear, with a different typefamily/style/color so that the reader will perceive the ‘speaker,’ via the supplied code (or from context), by recognition of the differing type colors and styles presenting the dialog, much like seeing individual actors in a movie and recognizing their appearance or hearing their voice thus eliminating much of the grammatical narrative, e.g. “he said,” “she exclaimed,” “he loudly retorted.”

2. A method of preparing printed media comprising:
providing at least one character voice in the printed media, wherein each of the at least one voice is distinguished in the printed media from other voices in the printed media by utilizing at least one of a unique type family, type size, type weight, and type color for each respective character voice.

3. A printed media device comprising:
printed media in which respective voices of at least one character are expressed in print, wherein each of the at least one voice is distinguished in the printed media from other voices in the printed media by utilizing at least one of a unique type family, type size, type weight, and type color for each respective character voice.
